(19) United States
(12) Patent Application Publication
(10) Pub. No.: US 2014/0186634 A1
(43) Pub. Date: Jul. 3, 2014

(54) LAMINATED ELECTROCAST SLEEVE AND FIXATION BELT

(71) Applicant: SYNZTEC CO., LTD., Tokyo (JP)

(72) Inventor: Minoru TAKEDA, Saitama (JP)

(73) Assignee: SYNZTEC CO., LTD., Tokyo (JP)

(21) Appl. No.: 14/141,971

(22) Filed: Dec. 27, 2013

(30) Foreign Application Priority Data
Dec. 28, 2012 (JP) 2012-289006

(51) Int. Cl. B32B 9/04; G03G 15/20

(52) U.S. Cl. CPC G03G 15/206
USPC 428/411.1; 399/333

(57) ABSTRACT

The present invention provides a laminated electrocast sleeve and a fixation belt having drastically enhanced durability. The laminated electrocast sleeve formed of a plurality of metal layers including at least a first metal layer, and a second metal layer provided around the first metal layer through electrocasting, wherein the first metal layer is isolated from the second metal layer, and the difference between the outer diameter of the first metal layer and the inner diameter of the second metal layer is 50 μm or less.

The entire disclosure of Japanese Patent Application No. 2012-289006 filed on Dec. 28, 2012 is expressly incorporated by reference herein.

### BACKGROUND OF THE INVENTION

1. Field of the Invention

The present invention relates to a laminated electrocast sleeve and to a fixation belt, which are particularly suitable for a fixation belt or a pressure roller of an image-forming apparatus such as a copying machine, a facsimile machine, or a laser beam printer.

2. Background Art

Image-forming apparatuses such as a copying machine, a facsimile machine, and a laser beam printer are equipped with a fixation unit, by which an unfixed toner image is fixed by means of heat and pressure. One type of fixation unit includes a sleeve-shaped fixation belt having an endless electrocast belt, and a pressure roller disposed so as to face opposite the fixation belt.

Such a fixation belt is employed so that a recording medium is passed through a nip portion between the fixation belt and the pressure roller opposite the fixation belt, whereby an unfixed toner image is fixed by means of heat and pressure.

Such a fixation belt is rotated so as to follow the rotation of a pressure roller, while the belt is repeatedly bent at the nip portion and the entrance and exit of the belt. Thus, repeated bending readily results in mechanical fatigue. In addition, recent trends for decrease in the diameter of the fixation belt cylinder and increase in the application pressure lead to a larger deformation at the nip portion of the fixation belt, whereby a very large bending stress is applied to the belt. Therefore, further durability is required for a fixation belt.

Currently, a metal belt produced through electrocasting is employed as the fixation belt, and the metal is nickel, a nickel alloy, or the like (see Patent Document 1). Such a metal belt having dimensional stability has problems. The larger the thickness, the poorer the flex resistance. When the thickness is small, buckling occurs in the axial direction during handling for processing or use as a fixation belt.

In order to enhance flexibility and strength, there has been proposed a fixation belt formed of an electrocast layer having three or more layers and a structure in which high-hardness electrocast nickel layer is sandwiched by low-hardness electrocast nickel layers (see Patent Document 2).

However, as printing speed and copying speed have increased in recent years, breakage of a fixation belt after repeated rotation with bending readily occurs.

Meanwhile, from the viewpoints of energy saving and high-speed printing in recent years, image fixation has been carried out by means of an IH heater. The fixation mode has high thermal efficiency. When the fixation mode is employed, rapid heating of the fixation belt is repeatedly carried out. In such a heating mode, the fixation belt is readily fatigued. Thus, there is demand for further enhancement in strength of the fixation belt.
Patent Document 1: Japanese Patent Application Laid-Open (kokai) No. 2004-286840
Patent Document 2: Japanese Patent Application Laid-Open (kokai) No. 2011-242731

### SUMMARY OF THE INVENTION

In view of the foregoing, an object of the present invention is to provide a laminated electrocast sleeve and a fixation belt having drastically enhanced durability.

In one aspect of the present invention to attain the aforementioned object, there is provided a laminated electrocast sleeve formed of a plurality of metal layers including at least a first metal layer, and a second metal layer provided around the first metal layer through electrocasting, wherein the first metal layer is isolated from the second metal layer, and the difference between the outer diameter of the first metal layer and the inner diameter of the second metal layer is 50 μm or less.

According to the invention, the first metal layer and the second metal layer are isolated from each other, and a clearance is provided between the first metal layer and the second metal layer. The clearance, having a thickness equivalent to half of the difference between the outer diameter of the first metal layer and the inner diameter of the second metal layer, is as small as 25 μm or less. Therefore, each metal layer has a neutral axis against bending. Thus, when the laminated electrocast sleeve is used in a rotational state, bending stress can be considerably reduced, and durability of the sleeve can be enhanced. Tensile strength is equivalent to that of a generally employed electrocast sleeve of a monolayer structure.

Preferably, the second metal layer is an electrocast metal layer provided, through electrocasting, around an oxide layer formed on an outer peripheral surface of the first metal layer.

According to the invention, the first metal layer and the second metal layer can be isolated from each other in a more consistent manner through intervention of the oxide film between the metal layers. Therefore, each metal layer has a neutral axis against bending. Thus, when the laminated electrocast sleeve is used in a rotational state, bending stress can be considerably reduced, and durability of the sleeve can be enhanced. Also, since the second metal layer can serve as an endless electrocast metal layer, tensile strength is equivalent to that of a generally employed electrocast sleeve of a monolayer structure.

Preferably, the oxide film is an oxide coating or an anodic oxide coating.

According to the invention, the first metal layer and the second metal layer can be isolated from each other in a more consistent manner through intervention of an oxide coating or an anodic oxide coating between the metal layers.

Preferably, the first metal layer is an electrocast metal layer produced through electrocasting.

According to the present invention, an endless electrocast metal layer having high strength can be produced by virtue of the first metal layer formed through electrocasting.

Preferably, the metal layers include at least one metal layer selected from a nickel layer and a nickel alloy layer.

According to the invention, at least one of the metal layers can be formed of high-strength nickel or a nickel alloy, whereby the thus-produced laminated electrocast sleeve formed of high-strength nickel or a nickel alloy receives considerably reduced bending stress, and durability thereof can be drastically enhanced.

In another aspect of the present invention, there is provided a fixation belt comprising a laminated electrocast sleeve as recited in any of the aforementioned embodiments, and an elastic layer provided around an outermost peripheral surface of the laminated electrocast sleeve.

The fixation belt according to the invention has a laminated electrocast sleeve having excellent tensile strength, bending resistance, and durability. Therefore, the fixation belt can be reliably used for a long period of time. Also, since the clearance between the metal layers has a small, limited thickness, the sleeve can be operated in a manner similar to that of a conventional sleeve.

As described above, according to the present invention, the metal layers are isolated from each other with a very small clearance. Therefore, each metal layer has a neutral axis against bending. Thus, when the laminated electrocast sleeve or the fixation belt is used in a rotational state, bending stress thereof can be considerably reduced, and durability thereof can be enhanced.

### BRIEF DESCRIPTION OF THE DRAWINGS

Various other objects, features, and many of the attendant advantages of the present invention will be readily appreciated as the same becomes better understood with reference to the following detailed description of the preferred embodiments when considered in connection with the accompanying drawings, in which:

FIG. 1A is a perspective view of the laminated electrocast sleeve of Embodiment 1:

FIG. 1B is a cross-section of the laminated electrocast sleeve of Embodiment 1:

FIG. 2 is a cross-section of a fixation unit employing the laminated electrocast sleeve of Embodiment 1 in a fixation belt;

FIG. 3 is a cross-section of another fixation unit employing the laminated electrocast sleeve of Embodiment 1 in a fixation belt;

FIG. 4 is a cross-section of another fixation unit employing the laminated electrocast sleeve of Embodiment 1 in a fixation belt;

FIG. 5 is a graph showing the relationship between the number of stacking and the number of folding operations until fatigue, when the electrocast metal layer is not heated;

FIG. 6 is a graph showing the relationship between the number of stacking and the number of folding operation until fatigue, when the electrocast metal layer is heated;

FIG. 7 is a graph showing the relationship between the type of the inter-metal layer oxide film and the number of folding operations until fatigue;

FIG. 8 is a graph showing the relationship between the time for leaving the electrocast metal layer in air to form natural oxide film, and the number of folding operations until fatigue; and

FIG. 9 is a graph showing the relationship between the number of rotational operations until break, and the thickness of an electrocast sleeve sample.

### DETAILED DESCRIPTION OF PREFERRED EMBODIMENTS

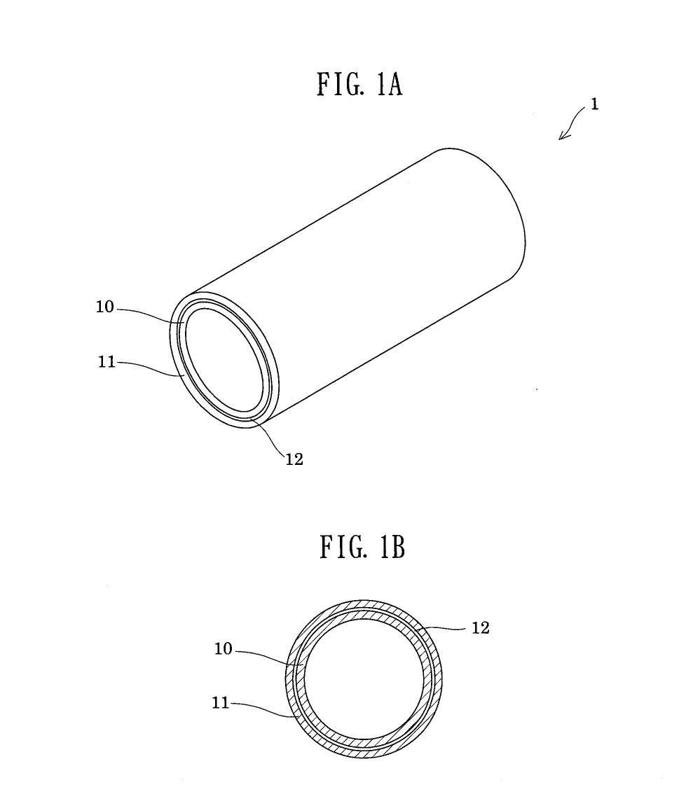

FIG. 1A is a perspective view and FIG. 1B is a cross-section of a laminated electrocast sleeve of the present embodiment. The laminated electrocast sleeve has at least one metal layer formed through electrocasting, with a plurality of such metal layers being laminated.

As shown in FIGS. 1A and 1B, a laminated electrocast sleeve 1 has a hollow cylinder. The laminated electrocast sleeve 1 has a stacked structure including a first metal layer 10, and a second metal layer 11 disposed around on the first metal layer 10, and the first metal layer 10 and the second metal layer 11 are isolated from each other. The isolation structure between the two metal layers is provided from a non-illustrated oxide film present between the first metal layer 10 and the second metal layer 11 and through interlayer isolation between the first metal layer 10 and the second metal layer 11, thereby leaving a clearance 12 between the metal layers.

Specifically, the laminated electrocast sleeve 1 is a stacked body provided by forming an oxide film around the outer peripheral surface of the first metal layer 10, and forming the second metal layer 11 on the oxide film. When the interface between the oxide film and the first metal layer 10, that between the oxide film and the second metal layer 11, or that between the first metal layer 10 and the second metal layer 11 is separated, or the oxide film is disrupted, the isolation structure between the first metal layer 10 and the second metal layer 11 is realized. Therefore, the clearance 12 has the same thickness as that of the originally present oxide film.

More specifically, the difference between the outer diameter of the first metal layer 10 and the inner diameter of the second metal layer 11 is 50 μm or less, preferably 30 μm or less, more preferably 20 μm or less, still more preferably 10 μm or less. Since the clearance 12 is provided between the first metal layer 10 and the second metal layer 11, the thickness of the clearance 12 is half of the difference between the outer diameter of the first metal layer 10 and the inner diameter of the second metal layer 11. So long as the first metal layer 10 and the second metal layer 11 are isolated by the mediation of the clearance 12, no particular limitation is imposed on the production method for the laminated electrocast sleeve. In an alternative procedure, a layer alternative to the oxide film is provided around the outer peripheral surface of the first metal layer 10; the second metal layer 11 is formed thereon through electrocasting; and the metal layers are isolated from each other.

Thus, the oxide film may not be present in the clearance 12, or at least a part of the oxide film may be present in the clearance 12. Alternatively, the clearance 12 has a thickness as small as zero. In a yet alternative procedure, the first metal layer 10 and the second metal layer 11 are separately formed through electrocasting or through another technique, and the two layers are stacked, to thereby realize a stacked structure provided with the clearance 12. However, after separate production of the layers, it is considerably difficult to stacking the metal layers having a subtle difference in diameter.

The laminated electrocast sleeve 1 has such a structure in which the two metal layers are isolated from each other, with the clearance 12 having a very small thickness between the metal layers. Thus, the sleeve has durability 10 to 10³ times that conventionally attained. Details will be described hereinbelow.

More specifically, a physical strength; e.g., tensile strength, of the first metal layer 10 and that of the second metal layer 11 are almost equivalent to that of the stacked body. However, the flex resistance of the laminated sleeve is remarkably enhanced, as compared with the flex resistance of a metal layer having the same thickness as that of the laminated sleeve, since the neutral axis against bending is present in each of the first metal layer 10 and the second metal layer 11, whereby the flex resistance of the laminated sleeve is the sum of the flex resistance of the first metal layer 10 and that of the second metal layer 11. Details will be described hereinbelow.

The first metal layer 10 is preferably formed of nickel, copper, SUS, aluminum, gold, silver, or an alloy thereof. Among these metal species, nickel or a nickel alloy, having high durability, is particularly preferred. Examples of the nickel alloy include nickel alloys each containing one or more elements selected from among phosphorus, iron, cobalt, manganese, and palladium.

No particular limitation is imposed on the method for producing the first metal layer 10, but electrocasting is preferred. When the first metal layer is produced through electrocasting, an endless metal layer having low surface roughness can be provided.

The second metal layer 11 is an electrocast metal layer formed through electrocasting. The second metal layer 11 is also preferably formed of nickel, copper, SUS, aluminum, gold, silver, or an alloy thereof, with nickel or a nickel alloy being particularly preferred. Although the first metal layer 10 and the second metal layer 11 are preferably formed of the same material, the two layers may also be formed of different materials.

Among the stacked metal layers, at least one metal layer thereof is preferably formed of high-durability nickel or a nickel alloy. By virtue of the presence of at least one nickel layer or nickel alloy layer, having high durability, the strength of the laminated electrocast sleeve can be enhanced. For example, when three metal layers are provided, the first metal layer may be formed of nickel, the second metal layer may be formed of copper, and the third metal layer may be formed of nickel. Needless to say, all of the first to third metal layers may be formed of the same material or of different materials.

The thickness of the first metal layer 10 and that of the second metal layer 11 are determined in consideration of the thickness of the laminated electrocast sleeve to be produced. For example, when the thickness of the laminated electrocast sleeve 1 is adjusted to 60 μm, the thickness of the first metal layer 10 or that of the second metal layer 11 is preferably about 30 μm. When the thickness of the laminated electrocast sleeve 1 is adjusted to 100 μm, each layer preferably has a thickness of about 50 μm. Needless to say, the first metal layer 10 and the second metal layer 11 may have different thicknesses. This will apply to the case where three or more metal layers are provided. In this case, the thickness of each metal layer relatively decreases.

No particular limitation is imposed on the type of the oxide film provided around the outer peripheral surface of the first metal layer 10, and the oxide film is preferably an oxide coating or an anodic oxide coating. As used herein, the term “oxide coating” encompasses naturally formed oxide film and thermally formed oxide film. The term “anodic oxide coating” refers to an oxide film formed on the metal layer when electricity is passed through the metal layer serving as an anode in electrolyte. Notably, the thickness of the oxide film may be some nanometers or more. No particular limitation is imposed on the thickness of the metal oxide layer, so long as interlayer isolation can be realized.

Through provision of such an oxide film, the first metal layer 10 and the second metal layer 11 can be isolated from each other, to thereby enhance the durability of the laminated electrocast sleeve 1.

The method for producing the laminated electrocast sleeve of the present invention will next be described.

In this embodiment, the first metal layer 10 and the second metal layer 11 are produced through electrocasting.

Firstly, the first metal layer 10 is formed. The first metal layer 10 is generally formed by use of a nickel electrocasting bath; for example, a Watts bath containing as a predominant component nickel sulfate or nickel chloride, or a sulfamate bath containing as a predominant component nickel sulfamate, with a cylindrical substrate made of stainless steel, brass, aluminum, etc. In electrocasting, a plating substrate is thick-plated, and the thus-formed metal layer is removed from the substrate, to thereby provide a metal product.

In the case where the plating substrate is made of a non-conducting material such as silicone resin or gypsum, the non-conducting substrate is subjected to a conducting-property-imparting treatment by use of graphite or copper powder, or through silver mirror reaction, sputtering, or a similar process. In the case where the plating substrate is made of a conductor, the surface of the substrate is preferably subjected to a release-facilitating treatment, for example, forming a release film such as oxide film, compound film, or graphite coating film, in order to facilitate removing the formed nickel plating film from the substrate.

The nickel electrocasting bath contains a nickel ion source, an anode-dissolving agent, a pH buffer, and other additives. Examples of the nickel ion source include nickel sulfamate, nickel sulfate, and nickel chloride. In the case of Watts bath, nickel chloride serves as an anode-dissolving agent. In the case of other nickel baths, ammonium chloride, nickel bromide, and other compounds are used. The nickel plating is generally performed at a pH of 3.0 to 6.2. In order to adjust the pH to fall within the preferred range, a pH buffer such as boric acid, formic acid, nickel acetate, or the like is used. Other additives employed in the nickel electrocasting bath include a brightener, a pit-corrosion-preventing agent, and an internal stress-reducing agent, for the purposes of smoothing, pit corrosion prevention, reducing crystal grain size, reduction of residual stress, etc.

The nickel electrocasting bath is preferably a sulfamate bath. One exemplary composition of the sulfamate bath includes nickel sulfamate tetrahydrate (300 to 600 g/L), nickel chloride (0 to 30 g/L), boric acid (20 to 40 g/L), a surfactant (appropriate amount), and a brightener (appropriate amount). The pH is 2.5 to 5.0, preferably 3.5 to 4.7, and the bath temperature is 20 to 65° C., preferably 40 to 60° C. The first layer formed of an electrocast nickel alloy may be produced in a nickel metal electrocasting bath appropriately containing a water-soluble phosphorus-containing acid salt (e.g., sodium phosphite), a metal sulfamate salt (e.g., ferrous sulfamate, cobalt sulfamate, or manganese sulfamate), palladium sulfamate, etc. Notably, when a nickel electrocasting bath appropriately containing a water-soluble phosphorus-containing acid salt, a metal sulfamate salt (e.g., ferrous sulfamate, cobalt sulfamate, or manganese sulfamate), palladium sulfamate, and other ingredients, an electrocast seamless belt formed of a nickel alloy containing one or more element selected from among phosphorus, iron, cobalt, manganese, and palladium may be formed. Needless to say, such an electrocast seamless belt may be employed as the first metal layer. Notably, the method for producing the first metal layer is not limited to electrocasting.

Then, an oxide film is formed on the outer peripheral surface of the first metal layer 10. When naturally formed oxide film is used as the oxide film, a plating substrate having the first metal layer is allowed to stand in air, to thereby naturally form an oxide film on the outer peripheral surface of the first metal layer 10. The time for allowing the substrate to stand in air may be several minutes or longer. Alternatively, the process may be performed for 12 hours or longer.

In the case where thermal oxide film is used as the oxide film, the plating substrate having the first metal layer 10 is heated by a heating mean; e.g., a halogen heater, a IR heater, or an electromagnetic induction heater, to thereby form a thermal oxide film having a specific thickness on the outer peripheral surface of the first metal layer 10.

In the case where anodic oxide coating is used as the oxide film, the oxide film is formed through anodization. Specifically, an anode is connected to the plating substrate having the first metal layer 10, and a cathode (power source) is connected to another metal member. The system is immersed in an electrolyte containing, for example, sodium hydroxide. Through passage of electricity at a constant current for a specific period of time, an anodic oxide coating having a specific thickness can be formed on the surface of the first metal layer 10.

Then, the second metal layer 11 is formed. In the case where the second metal layer 11 and the first metal layer 10 are made of the same material, the two layers may be formed in the same electrocasting bath. Needless to say, different electrocasting baths may also be used. In the case where the second metal layer 11 is formed from a material different from that of the first metal layer 10, the second metal layer 11 formed of the different material may be produced by use of an electrocasting bath containing a metal of interest. The formation procedure is the same as employed for forming the first metal layer 10.

A known electroplating bath may be used. In the case where the metal layer is formed from electrocast nickel, a sulfamate bath is preferably used. Alternatively, a nickel sulfate bath, a Watts bath, or such a bath to which phosphorus, iron, cobalt, manganese, palladium, etc. have been added may also be used.

The thus-produced laminated electrocast sleeve 1 has drastically improved durability. The reason for such enhancement in durability is the presence of a structure in which the first metal layer 10 and the second metal layer 11 are isolated from each other by the mediation of the oxide film formed on the outer peripheral surface of the first metal layer 10.

When the laminated electrocast sleeve 1 is employed in a fixation belt of a fixation unit, tensile stress is applied to the outer surface of the fixation belt, and compressive stress is applied to the inner surface of the fixation belt, during rotation of the fixation belt. However, there exists a site where no tensile stress or compressive stress is applied. The site is called a “neutral axis” against bending. The neutral axis is generally present at the center in the thickness direction of the laminated electrocast sleeve.

According to the present invention, at least two metal layers are provided, and the metal layers are isolated from one another. Thus, the neutral axis against bending is conceivably present at the half depth of each metal layer.

Therefore, the flex resistance of the fixation belt is equivalent to the total flex resistance of the layers. Thus, bending stress resistance of the fixation belt can be considerably reduced, and durability of the fixation belt can be drastically improved. Such high durability is 10 to 10³ times that of conventional fixation belts. Tensile strength is equivalent to that of a conventional fixation belt of a monolayer structure.

In the laminated electrocast sleeve 1 falling within the scope of the present invention, the metal layers are isolated in the presence of clearance therebetween, whereby each metal layer has a neutral axis against bending during rotational operation. Thus, bending stress can be considerably reduced, and flex resistance can be drastically improved.

When the difference between the outer diameter of the first metal layer 10 and the inner diameter of the second metal layer 11 is in excess of 100 μm, one metal layer slips with respect to the adjacent metal layer. In this case, the structure cannot serve as an electrocast sleeve having an integrated layer structure.

Therefore, it is useful that the difference between the outer diameter of the first metal layer 10 and the inner diameter of the second metal layer 11 is adjusted to 50 μm or less; i.e., the thickness of the clearance 12 is adjusted to 25 μm or less. Through adjusting the thickness of the clearance 12 to fall within the range, the laminated electrocast sleeve 1 of the present invention can be employed as a conventional sleeve of an integrated monolayer structure.

In addition, the laminated electrocast sleeve 1 of the present invention has heat resistance higher than that of a conventional electrocast sleeve of a monolayer structure (see FIG. 6). Details will be described hereinbelow. In the case where a fixation belt of a fixation unit is produced by processing an electrocast nickel sleeve having an integrated layer structure, heat treatment must be performed for forming a release layer (e.g., a fluororesin layer) on the outer peripheral surface of the electrocast sleeve. In such a case, nickel maintained at high temperature is problematically embrittled.

Even when a high temperature (e.g., 350° C.) is applied during formation of such a release layer, the laminated electrocast sleeve 1 of the present invention has sufficient heat resistance. Thus, even when embrittlement of nickel occurs at high temperature, breakage of the sleeve is prevented by virtue of small bending stress.

Next, the fixation belt of the present invention will be described. The fixation belt has the aforementioned laminated electrocast sleeve 1 having drastically improved flex resistance, and an elastic layer formed of an elastic material (e.g., silicone rubber) provided on the outermost surface of the laminated electrocast sleeve 1. By virtue of the structural characteristics, the fixation belt can be reliably used for a long period of time, while deterioration or damage is prevented.

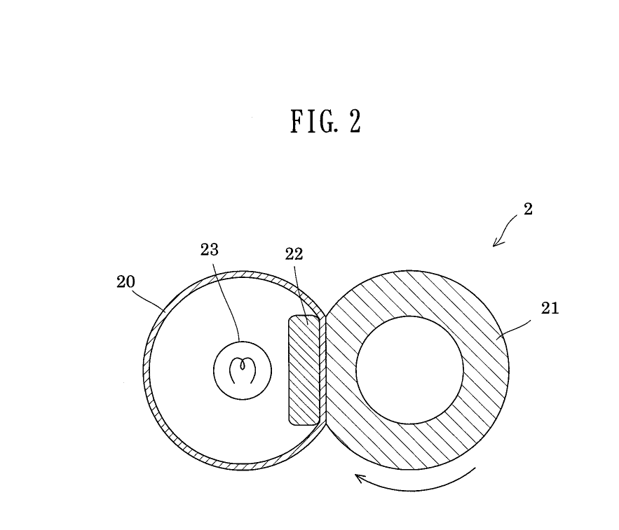

FIGS. 2 to 4 are cross-sections of fixation units each employing the laminated electrocast sleeve 1 in a fixation belt.

A fixation apparatus 2 is employed in an image-forming apparatus and fixes an unfixed toner image onto a recording medium through heat and pressure.

The fixation apparatus 2 shown in FIG. 2 has a fixation belt 20, a pressure roller 21 disposed so as to face opposite the fixation belt 20, and a pressure member 22 that outwardly presses the fixation belt 20 against the opposite pressure roller 21, to thereby form a specific nip portion. A heating means 23 for heating the fixation belt 20 to a predetermined temperature is disposed inside the fixation belt 20.

The pressure member 22 is formed of an elastic material such as rubber. The elastic pressure member may be coated with an optional layer such as a fluororesin layer.

The pressure roller 21 consists of a core made of metal or the like, and an elastic layer which is made of rubber or the like and which is formed on the peripheral surface of the core. The outer surface of the elastic layer may optionally be provided with a release layer formed of a fluororesin or the like.

No particular limitation is imposed on the heating means 23, so long as it can heat the fixation belt 20. Examples of the heating means include a halogen heater, a Nichrome heater, an infrared heater, and an electromagnetic induction heater with an exciting coil (heat source).

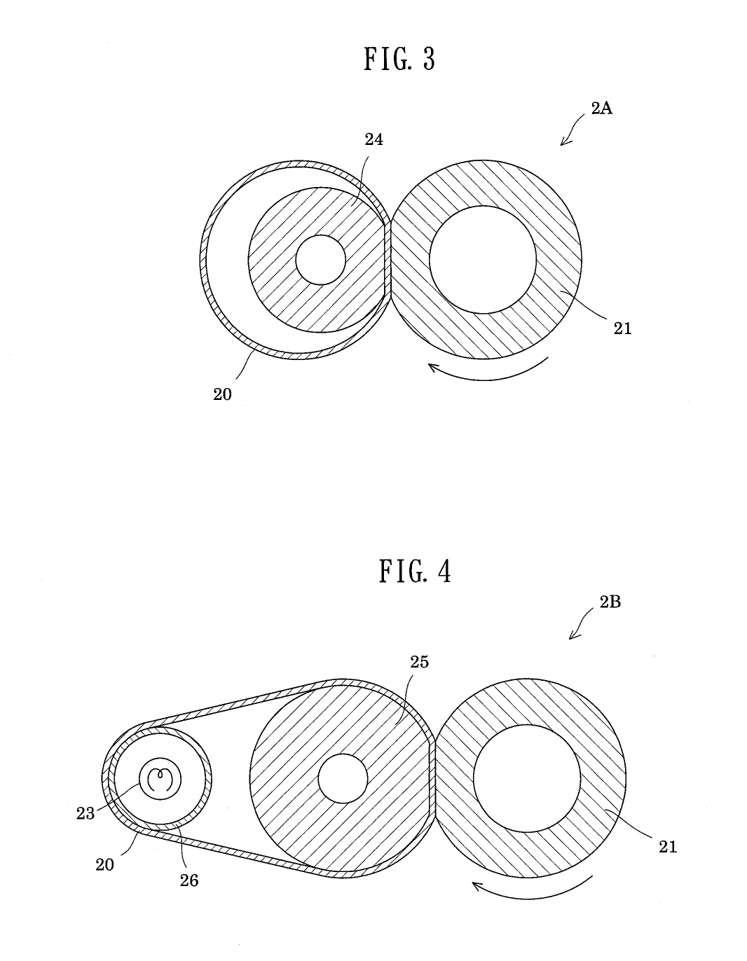

A fixation apparatus 2A shown in FIG. 3 has a fixation belt 20, a pressure roller 21 disposed so as to face opposite the fixation belt 20, and, instead of the pressure member 22, a fixation roller 24 that outwardly presses the fixation belt 20 against the pressure roller 21. A heating means for heating the fixation belt 20 (not illustrated) may be disposed outside the fixation belt 20.

A fixation apparatus 2B shown in FIG. 4 has a fixation belt 20, a pressure roller 21 disposed so as to face opposite the fixation belt 20, an inner roller 25 that outwardly presses the fixation belt 20 against the pressure roller 21, and a heating roller 26 inside which heating means is disposed. In the fixation belt 20, the inner roller 25 and the heating roller 26 are disposed, whereby the fixation belt 20 is rotated by means of the inner roller 25 and the heating roller 26.

### EXAMPLES

Table 1 shows the elements of laminated electrocast sleeves produced through the procedures of Examples 1 to 10, and Comparative Examples 1 to 6.

### Example 1

According to the aforementioned embodiments, a laminated electrocast sleeve 1 was produced in the following manner.

A phosphorus nickel sulfamate electrocast bath of interest was prepared from nickel sulfamate (500 g/L), sodium phosphite (150 mg/L), boric acid (30 g/L), trisodium naphthalene-1,3,6-trisulfonate (1.0 g/L) serving as a primary brightener, and 2-butyne-1,4-diol (20 mg/L) serving as a secondary brightener.

While the electrocast bath was maintained at 60° C. and a pH of 4.5, electrocasting was performed with a stainless steel cylindrical substrate (outer diameter: 30 mm) serving as a cathode, and a depolarized nickel serving as an anode at a current density of 16 A/dm², to thereby deposit a nickel-phosphorus alloy film having a thickness of 30 μm on the outer surface of the metal substrate.

Subsequently, anodization was performed in an anodization bath at 4.3 A for 150 seconds. The aforementioned electrocast film-deposited metal substrate was employed as an anode, and a nickel tube (φ: 50) was employed as a cathode. Cleaner 108 (product of Taiho, containing 30% sodium hydroxide, 70% other ingredients) was used at 30 g/L. As a result, an anodic oxide coating was formed on the outer peripheral surface of the first metal layer 10.

Then, the first metal layer 10 on which an anodic oxide coating had been formed was subjected to electrocasting in the same bath as employed for forming the first metal layer 10 through the same procedure, while the first metal layer 10 was not removed from the metal substrate. Thus, a second metal layer 11 having a thickness of 30 μm made of a nickel-phosphorus alloy was formed, and the metal laminate was removed from the metal substrate, to thereby yield the laminated electrocast sleeve 1.

The thus-produced laminated electrocast sleeve 1 had two metal layers, with each metal layer having a thickness of 30 μm and the total thickness being 60 μm.

### Example 2

In Example 2, the laminated electrocast sleeve 1 produced in Example 1 was heated in an electric furnace at 350° C. for 30 minutes. Other conditions were the same as employed in Example 1.

### Example 3

In Example 3, an anodic oxide coating was further formed on the outer peripheral surface of the second metal layer of the laminated electrocast sleeve 1 produced in Example 1, to thereby form a third metal layer. The thus-produced laminated electrocast sleeve had three metal layers. Each metal layer had a thickness of 20 μm, and the total thickness of the three layers was 60 μm.

The thickness of each metal layer was adjusted by tuning electrocasting time. Other conditions were the same as employed in Example 1.

### Example 4

In Example 4, the laminated electrocast sleeve produced in Example 3 was heated at 350° C. for 30 minutes in an electric furnace. Other conditions were the same as employed in Example 3.

### Example 5

In Example 5, an anodic oxide coating was further formed on the outer peripheral surface of the third metal layer of the laminated electrocast sleeve produced in Example 3, to thereby form a fourth metal layer. The thus-produced laminated electrocast sleeve had four metal layers. Each metal layer had a thickness of 15 μm, and the total thickness of the three layers was 60 μm. Other conditions were the same as employed in Example 3.

### Example 6

In Example 6, the laminated electrocast sleeve produced in Example 5 was heated at 350° C. for 30 minutes in an electric furnace. Other conditions were the same as employed in Example 5.

### Example 7

In Example 7, the metal substrate on which the first metal layer had been formed in Example 1 was allowed to stand, to thereby form a natural oxide film on the outer peripheral surface of the first metal layer. The leaving time was 12 hours. The thus-produced laminated electrocast sleeve had two metal layers. Each metal layer had a thickness of 30 μm, and the total thickness of the two layers was 60 μm. Other conditions were the same as employed in Example 1.

### Example 8

In Example 8, the laminated electrocast sleeve produced in Example 7 was heated at 350° C. for 30 minutes in an electric furnace. Other conditions were the same as employed in Example 7.

### Example 9

In Example 9, the leaving time employed in Example 7 was changed to 6 minutes, to thereby form a natural oxide film on the outer peripheral surface of the first metal layer. Other conditions were the same as employed in Example 7.

### Example 10

In Example 10, the leaving time employed in Example 7 was changed to 9 minutes, to thereby form a natural oxide film on the outer peripheral surface of the first metal layer. Other conditions were the same as employed in Example 7.

### Comparative Example 1

In Comparative Example 1, an electrocast sleeve formed of an electrocast nickel-phosphorus alloy single layer having a thickness of 60 μm, was produced through the same procedure and by use of the same electrocasting bath as employed in Example 1.

### Comparative Example 2

In Comparative Example 2, the laminated electrocast sleeve produced in Comparative Example 1 was heated at 350° C. for 30 minutes in an electric furnace.

### Comparative Example 3

In Comparative Example 3, an electrocast sleeve formed of an electrocast nickel-phosphorus alloy single layer having a thickness of 30 μm, was produced through the same procedure and by use of the same electrocasting bath as employed in Example 1.

### Comparative Example 4

In Comparative Example 4, the laminated electrocast sleeve produced in Comparative Example 3 was heated at 350° C. for 30 minutes in an electric furnace.

### Comparative Example 5

In Comparative Example 5, the leaving time employed in Example 7 was changed to 20 seconds. Other conditions were the same as employed in Example 7.

### Comparative Example 6

In Comparative Example 6, the leaving time employed in Example 7 was changed to 30 seconds. Other conditions were the same as employed in Example 7.

### Test Example 1

Electrocast sleeves produced in Examples 1 to 10 and Comparative Examples 1 to 6 were subjected to a folding endurance test by means of a folding endurance tester (MIT) (MIT-DA, product of Toyo Seiki Co., Ltd.). The durability of each electrocast sleeve was evaluated by the number of folding operations until breakage (i.e., endurance folding number).

Each of the produced electrocast sleeves was cut into slips having a width of 15 mm. An end of the slip was polished by means of sand paper (No. 1,000), to thereby prepare MIT samples. The MIT test was performed under the following conditions: load; 1.0 kg, swing angle; 90°, speed; 170 times/min, test segment; R 2 mm, and number of samples; 3. The MIT was performed in air at room temperature. The MIT test was performed in accordance with JIS P8115.

Firstly, unheated electrocast sleeve samples were subjected to the MIT test (Examples 1, 3, and 5, and Comparative Examples 1 and 3).

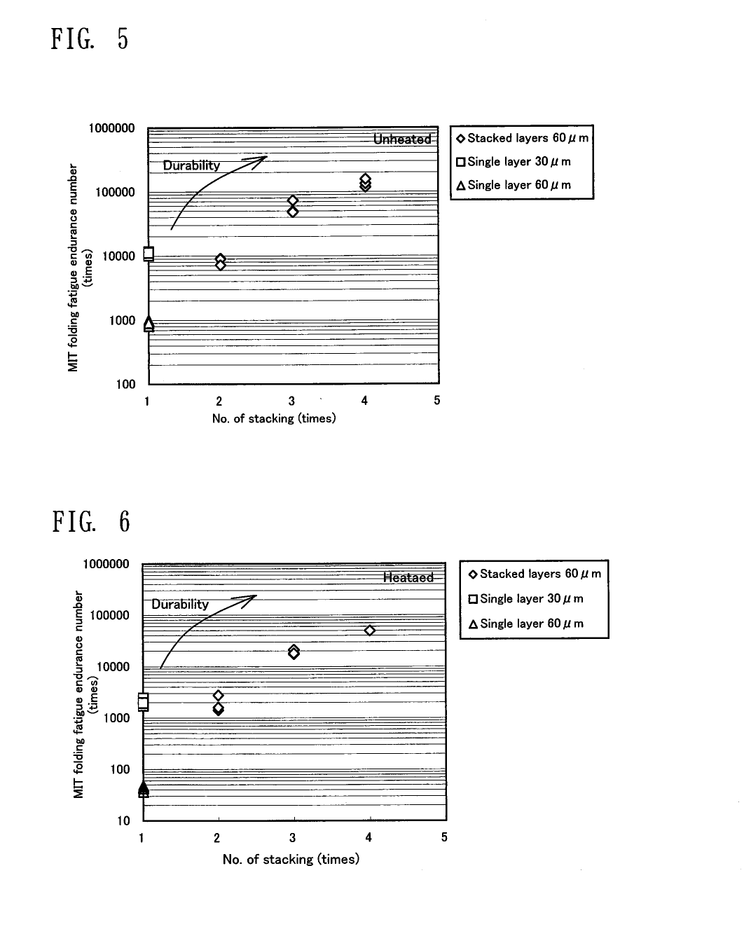

FIG. 5 is a graph showing the relationship between the number of stacking and the number of folding operations until fatigue (i.e., folding fatigue endurance number).

As shown in FIG. 5, in the case where an unheated electrocast sleeve sample having a total metal layer thickness of 60 μm was tested, the folding fatigue endurance number was about 10,000 to about 200,000, when the sample has two or more stacked metal layers. The folding fatigue endurance number was about 10 times to 200 times that obtained by a similar electrocast sleeve sample having a single metal layer (hereinafter referred to as “single-layer electrocast”). Such an excellent property was attained, since the electrocast sleeves of Examples 1, 3, and 5 had a metal layer isolation structure, whereby a neutral axis against bending was present in each metal layer. The metal layer isolation structure was partially and visually observed.

Then, heated electrocast sleeve samples were subjected to the MIT test (Examples 2, 4, and 6, and Comparative Examples 2 and 4).

FIG. 6 is a graph showing the relationship between the number of stacking and the number of folding operations until fatigue (i.e., folding fatigue endurance number).

As shown in FIG. 6, in the case where a heated electrocast sleeve sample was tested, the folding fatigue endurance number was about 3,000 to about 60,000, when the sample has two or more stacked metal layers. The folding fatigue endurance number was about 50 times to 1,000 times that obtained by a similar single-layer electrocast. Thus, stacking at least two metal layers was found to drastically enhance the folding fatigue endurance number, as compared with a conventional single-layer electrocast. Furthermore, when the number of stacking increased, the folding fatigue endurance number was found to be more enhanced. Such an excellent property was attained, since a neutral axis against bending was formed in each metal layer, and the number of neutral axes formed in the entire metal layer structure increased, as the number of stacking operations increases. The metal layer isolation structure was partially and visually observed.

A stacked structure including two metal layers each having a thickness of 30 μm (hereinafter referred to as “2-stack electrocast”) was compared with a single-layer electrocast having a single metal layer having a thickness of 30 μm, in terms of the folding fatigue endurance number. As a result, in the case where the electrocast sleeve had not been heated and in the case where the electrocast sleeve had been heated, almost the same value was obtained. Therefore, a neutral axis against bending was present in each metal layer of the 2-stack electrocast, and the flex resistance of the 2-stack electrocast (30 μm×2) was found to correspond to the sum of the flex resistance of single-layer electrocasts each having a thickness of each metal layer (30 μm). Thus, the flex resistance of a 2-stack electrocast (30 μm×2) was remarkably higher than that of a single-layer electrocast (60 μm). Conceivably, such enhancement in flex resistance was attributed to an isolation structure in which each metal layer of the 2-stack electrocast and the oxide film was separated and isolated.

As shown in FIG. 6, when a laminated electrocast sleeve had been heated, the folding fatigue endurance number was found to be about 50 times to about 1,000 times, as compared with a conventional single-layer electrocast sleeve. Thus, through heating the surface of the laminated electrocast sleeve or sites thereof, a drop in heat resistance was able to be prevented, whereby various types of processing of laminated electrocast sleeves were realized.

Then, electrocast sleeves having different inter-metal-layer oxide films (Examples 1, 2, 7, and 8) were subjected to the MIT test.

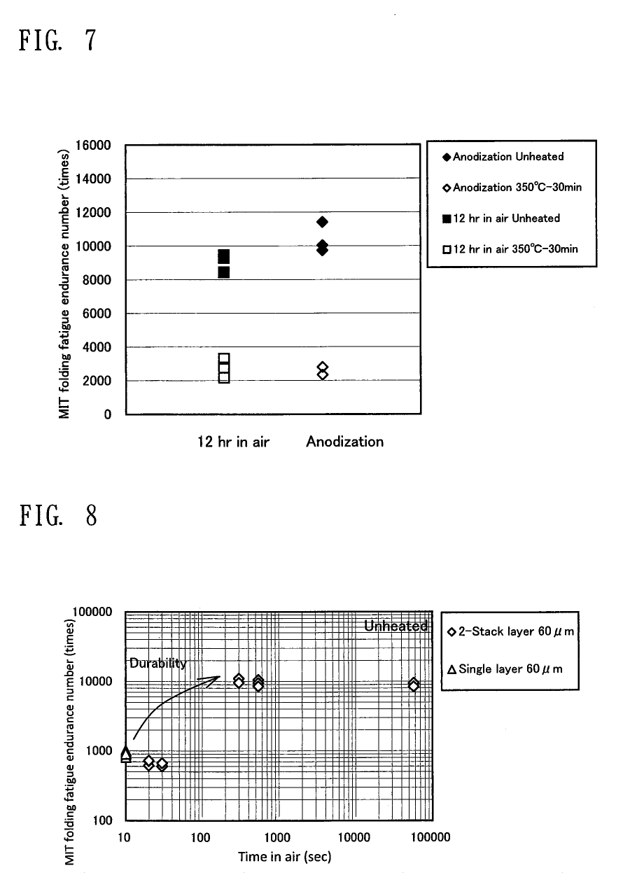

FIG. 7 is a graph showing the relationship between the type of the inter-metal layer oxide film and the folding fatigue endurance number. In each 2-stack electrocast, metal layers are isolated, and the clearance between the metal layers is thought to have a thickness corresponding to the thickness of oxide film. However, the actual thickness of the oxide film was not able to be measured. Conceivably, the thickness of each oxide film is several nanometers to several micrometers.

As shown in FIG. 7, when the oxide film provided around the peripheral surface of the first metal layer was naturally occurring oxide film, and when the oxide film was an anodic oxide coating, the folding fatigue endurance number was able to be maintained at high level. Particularly, the anodic oxide coating can be formed within a very short period of time (150 seconds), whereby laminated electrocast sleeve productivity can be enhanced.

Then, while the leaving time for forming inter-metal-layer natural oxide film was varied, electrocast sleeves were produced (Examples 7, 9, and 10, and Comparative Examples 1, 5, and 6). The produced sleeves were subjected to the MIT test. The tested electrocast sleeves were not subjected to heat treatment.

FIG. 8 is a graph showing the relationship between the time for leaving the electrocast metal layer in air, and the folding fatigue endurance number.

As shown in FIG. 8, instead of allowing the metal layer to stand for 12 hours, a leaving time as short as about 6 minutes was found to be sufficient for maintaining high folding fatigue endurance number. In addition, when the metal layer was allowed to stand in air for 6 minutes or longer, the folding fatigue endurance number of a 2-stack electrocast was able to be considerably enhanced as compared with a single-layer electrocast. Notably, when the leaving time was as short as about 20 seconds or about 30 seconds, natural oxide film was not formed. Thus, the folding fatigue endurance number was thought to decrease. In other words, the presence of oxide film between metal layers enhances the folding fatigue endurance number.

### Test Example 2

The electrocast sleeves produced in Example 7 and Comparative Example 1 were subjected to a biaxial rotation test under heating by means of a biaxial heating rotation tester (TMS-S-2000, product of Tomoe Sangyo).

Each of the electrocast sleeves of Example 7 and Comparative Example 1 was cut into slips having a width of 5 mm. An end of the slip was polished by means of sand paper (No. 1,000). The absence of fins on the slip was checked by finger touching. The slip samples were washed with acetone, coated with a black body material, dried in air, and dried at 150° C. for 30 minutes, to thereby prepare rotational test samples.

The test conditions were as follows: load; 2.0 kg, pulley diameter (drive shaft); φ10, pulley diameter (follow shaft); φ5, test speed; 3,600 rpm, and test temperature; 180° C. The rotation test was performed in air.

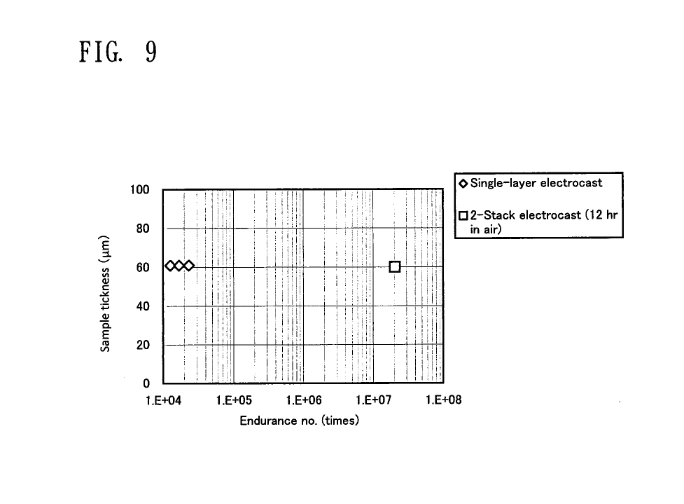

FIG. 9 is a graph showing the relationship between the rotation endurance number, and the thickness of an electrocast sleeve sample.

As shown in FIG. 9, when the thickness of the entire metal layer was 60 μm, a 2-stack electrocast was not broken after more than 10,000,000 rotations, while a single-layer electrocast was broken after about 10,000 rotations. Thus, the 2-stack electrocast was found to have a flex resistance about 1,000 times that of the single-layer electrocast.

Thus, according to the laminated electrocast sleeve of the present invention, flex resistance can be drastically enhanced by stacking a plurality of metal layers.

Also, the fixation belt of the present invention has a laminated electrocast sleeve having such high flex resistance that the fixation belt can be reliably operated for a long period of time.

TABLE 1

| | Metal | | | | | |
|---|---|---|---|---|---|---|
| | layer total | No. of | Thickness | | Oxide | Heat |
| | thickness | metal | of metal | Oxide | film | treat- |
| | (μm) | layers | layer | film | formation | ment |
| Ex. 1 | 60 μm | 2 | 30 μm | Anodic | 4.3 A, | No |
| | | | | oxide | 150 s | |
| | | | | coating | | |
| Ex. 2 | 60 μm | 2 | 30 μm | Anodic | 4.3 A, | Yes |
| | | | | oxide | 150 s | |
| | | | | coating | | |
| Ex. 3 | 60 μm | 3 | 20 μm | Anodic | 4.3 A, | No |
| | | | | oxide | 150 s | |
| | | | | coating | | |
| Ex. 4 | 60 μm | 3 | 20 μm | Anodic | 4.3 A, | Yes |
| | | | | oxide | 150 s | |
| | | | | coating | | |
| Ex. 5 | 60 μm | 4 | 15 μm | Anodic | 4.3 A, | No |
| | | | | oxide | 150 s | |
| | | | | coating | | |
| Ex. 6 | 60 μm | 4 | 15 μm | Anodic | 4.3 A, | Yes |
| | | | | oxide | 150 s | |
| | | | | coating | | |
| Ex. 7 | 60 μm | 2 | 30 μm | Natural | 12 hours | No |
| | | | | oxide | in air | |
| | | | | film | | |
| Ex. 8 | 60 μm | 2 | 30 μm | Natural | 12 hours | Yes |
| | | | | oxide | in air | |
| | | | | film | | |
| Ex. 9 | 60 μm | 2 | 30 μm | Natural | 6 min | No |
| | | | | oxide | in air | |
| | | | | film | | |
| Ex. 10 | 60 μm | 2 | 30 μm | Natural | 9 min | No |
| | | | | oxide | in air | |
| | | | | film | | |
| Comp. | 60 μm | 1 | 60 μm | — | — | No |
| Ex. 1 | | | | | | |
| Comp. | 60 μm | 1 | 60 μm | — | — | Yes |
| Ex. 2 | | | | | | |
| Comp. | 30 μm | 1 | 30 μm | — | — | No |
| Ex. 3 | | | | | | |
| Comp. | 30 μm | 1 | 30 μm | — | — | Yes |
| Ex. 4 | | | | | | |
| Comp. | 60 μm | 2 | 30 μm | — | 20 sec | No |
| Ex. 5 | | | | | in air | |
| Comp. | 60 μm | 2 | 30 μm | — | 30 sec | No |
| Ex. 6 | | | | | in air | |

### Other Embodiments

Although one embodiment of the present invention has been described above, the basic constitution of the present invention is not limited to the aforementioned embodiment. Although the laminated electrocast sleeve of the present invention is suitably employed in the aforementioned fixation belt, the sleeve may be employed in a transfer/fixation belt for sequential image transfer and fixation, or another belt. Thus, no particular limitation is imposed on the mode of use of the laminated electrocast sleeve.

What is claimed is:

1. A laminated electrocast sleeve formed of a plurality of metal layers including at least a first metal layer, and a second metal layer provided around the first metal layer through electrocasting,
wherein the first metal layer is isolated from the second metal layer, and
the difference between the outer diameter of the first metal layer and the inner diameter of the second metal layer is 50 μm or less.

2. A laminated electrocast sleeve according to claim 1, wherein the second metal layer is an electrocast metal layer provided, through electrocasting, around an oxide layer formed on an outer peripheral surface of the first metal layer.

3. A laminated electrocast sleeve according to claim 2, wherein the oxide film is an oxide coating or an anodic oxide coating.

4. A laminated electrocast sleeve according to claim 1, wherein the first metal layer is an electrocast metal layer produced through electrocasting.

5. A laminated electrocast sleeve according to claim 2, wherein the first metal layer is an electrocast metal layer produced through electrocasting.

6. A laminated electrocast sleeve according to claim 3, wherein the first metal layer is an electrocast metal layer produced through electrocasting.

7. A laminated electrocast sleeve according to claim 1, wherein the metal layers include at least one metal layer selected from a nickel layer and a nickel alloy layer.

8. A fixation belt comprising:
a laminated electrocast sleeve as recited in claim 1, and
an elastic layer provided around an outermost peripheral surface of the laminated electrocast sleeve.
